(19) United States
(12) Patent Application Publication
(10) Pub. No.: US 2014/0152562 A1
(43) Pub. Date: Jun. 5, 2014

(54) DISPLAY CONTROLLER, DISPLAY SYSTEM, STORAGE MEDIUM AND METHOD

(71) Applicant: NINTENDO CO., LTD., Kyoto (JP)

(72) Inventors: Toshiaki SUZUKI, Kyoto (JP); Akihiro UMEHARA, Kyoto (JP)

(21) Appl. No.: 13/927,635

(22) Filed: Jun. 26, 2013

(30) Foreign Application Priority Data
Dec. 4, 2012 (JP) 2012-265830

(51) Int. Cl. G09G 5/00

(52) U.S. Cl. CPC G09G 5/005
USPC 345/158

(57) ABSTRACT

An exemplary display controller includes: an attitude detecting unit configured to detect an attitude of a terminal device; a first display controlling unit configured to control a display unit to display a partial image that is clipped in response to the detected attitude from a panoramic image corresponding to a position; a determining unit configured to determine a direction in which the position is moving; and a second display controlling unit configured to update, in response to a first operation input, an image displayed on the display unit from the first partial image to a second partial image that is clipped in response to the determined direction from the panoramic image.

### CROSS REFERENCE TO RELATED APPLICATION

The disclosure of Japanese Patent Application No. 2012-265830, filed on Dec. 4, 2012, is incorporated herein by reference.

### FIELD

The present disclosure relates to displaying a panoramic image corresponding to a position on a map.

### BACKGROUND AND SUMMARY

Technologies for displaying a part of a picture (a panoramic image) captured at a point on a map are known.

The present disclosure enables a user to understand with ease a direction of a pathway when plural panoramic images are sequentially displayed.

There is provided a display controller including: an attitude detecting unit configured to detect an attitude of a terminal device; a first display controlling unit configured to control a display unit to display a partial image that is clipped in response to the detected attitude from a panoramic image corresponding to a position; a determining unit configured to determine a direction in which the position is moving; and a second display controlling unit configured to update, in response to a first operation input, an image displayed on the display unit from the first partial image to a second partial image that is clipped in response to the determined direction from the panoramic image.

### BRIEF DESCRIPTION OF THE DRAWINGS

Exemplary embodiments will be described with reference to the following drawings, wherein:

FIG. 1 shows an example of a configuration of display system 10;

FIG. 2 shows an example of a hardware configuration of terminal device 200;

FIG. 3 shows an example of a hardware configuration of information-processing device 300;

FIG. 4 shows an example of a functional configuration of information-processing device 300;

FIG. 5 shows an example of a map image;

FIG. 6 shows an example of position data corresponding to a map image;

FIG. 7 shows an example of a structure of a panoramic image;

FIG. 8 shows an example of links with panoramic images;

FIG. 9 shows an example of displayed images on display device 100 and terminal device 200;

FIG. 10 shows another example of displayed images on display device 100 and terminal device 200;

FIG. 11 shows an example of a sequence chart illustrating a process in display system 10;

FIG. 12 shows an example of a sequence chart illustrating a process for changing a displayed image in response to an attitude of terminal device 200;

FIG. 13 shows an example of a flowchart illustrating a process for updating a displayed partial image from an image corresponding to a position to another image corresponding to another image; and

FIG. 14 shows an example of a transition of screen images from the first partial image to the third partial image.

### DETAILED DESCRIPTION OF NON-LIMITING EXEMPLARY EMBODIMENT

### 1. Exemplary Embodiment

FIG. 1 shows an example of a configuration of display system 10 according to one exemplary embodiment. Display system 10 provides a service for displaying information relating to a map. Hereinafter, the service is referred to as a “map displaying service.” In this example, the map shows geographical information on the earth. Display system 10 includes display device 100, terminal device 200, information-processing device 300 (main unit), and server device 500. Information-processing device 300 and server device 500 are connected via network 400.

Display device 100 is a stationary display device, for example, a television. In this example, display device 200 has a larger display area than terminal device 200. It is to be noted that display device 100 is not restricted to a television, and may be a projector that projects an image onto a screen or a wall.

Terminal device 200 is an input device that receives an operation input by a user and also is an output device that displays an image. In this case, terminal device 200 is a portable display device. A user operates terminal device 200, for example, by pushing a button and/or tilting terminal device 200 with terminal device 200 being held in his/her hands. By the operation, an image displayed on terminal device 200 is changed. It is to be noted that a user may input an operation by touching a screen of terminal device 200, as well as by pushing a button.

Information-processing device 300 is a computer device that controls displaying of an image on display device 100 and terminal device 200. Information-processing device 300 receives data for controlling display of data in response to an operation input by a user, and provides display data to display device 100 and terminal device 200. Here, “display data” is data for controlling each of display device 100 and terminal device 200 to display an image.

Server device 500 is a computer device that provides information relating to a map. Hereinafter, “map data” refers to information provided by server device 500. In this example, the map data is stored in a storing unit of server device 500. However, the map data may be stored in an external storage device and server device 500 may read the map data from the storage device. Plural devices may perform distributed processing for implementing functions of server device 500. In other words, display system 10 may include at least one server device 500.

The map data includes image data showing a map of a given position, and image data showing a panoramic image. The map image is an image showing a map. The panoramic image is an image showing a view from a given position and corresponds to views in various directions from the given position.

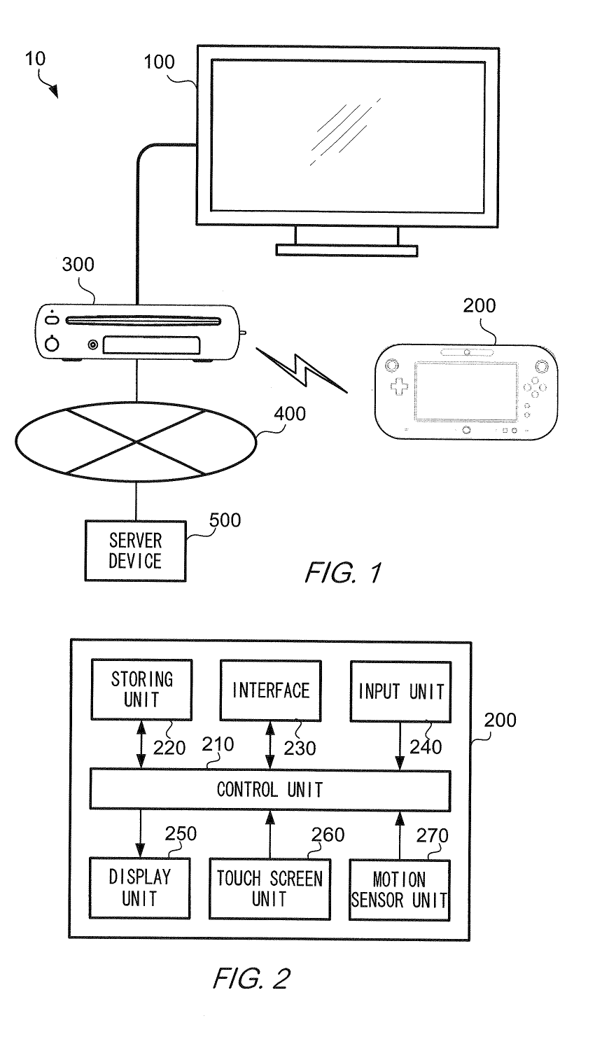

FIG. 2 shows an example of a hardware configuration of terminal device 200. Terminal device 200 includes control unit 210, storing unit 220, interface 230, input unit 240, display unit 250, touch screen unit 260, and motion sensor unit 270.

Control unit 210 controls hardware components of terminal device 200. Control unit 210 includes a processor such as a CPU (Central Processing Unit) and a memory, and executes various processes by causing the CPU to execute a program.

Storing unit 220 stores data. Storing unit 220 includes a storage device such as a flash memory, and stores data used for a process executed by control unit 210.

Interface 230 communicates data with information-processing device 300. Interface 230 includes an antenna and a modem, and communicates with information-processing device 300 in accordance with a predetermined communication protocol. For example, interface 230 communicates with information-processing device 300 via a wireless LAN (Local Area Network).

Input unit 240 receives an operation input by a user. Input unit 240 includes a button and/or a lever, and provides to control unit 210 data showing an operation input by a user.

Display unit 250 displays an image. Display unit 250 includes a display panel of a liquid crystal device or an organic EL (electroluminescence) device, as well as a driver circuit thereof, and displays data in accordance with display data.

Touch screen unit 260 receives an operation input via a screen by a user. Touch screen unit 260 includes a touch sensor mounted on a display panel, and provides coordinate data showing a position (coordinate) touched by a user. A user can identify a position on a screen using his/her finger or a stylus.

Motion sensor unit 270 detects motion of terminal device 200. Motion sensor unit 270 includes, for example, an acceleration sensor (a triaxial acceleration sensor) for measuring an acceleration of terminal device 200, a gyro sensor for measuring a change of angle or an angular velocity of terminal device 200, and an earth magnetism sensor for measuring an earth magnetism. Motion sensor unit 270 provides to control unit 210 sensor data showing the measured physical quantity. For example, if terminal device 200 is tilted, terminal device 200 outputs sensor data showing the direction of tilt.

In this embodiment, operation input data, coordinate data, and sensor data are used as data showing an operation input by a user. Hereinafter, these data are generally referred to as “operation input data.”

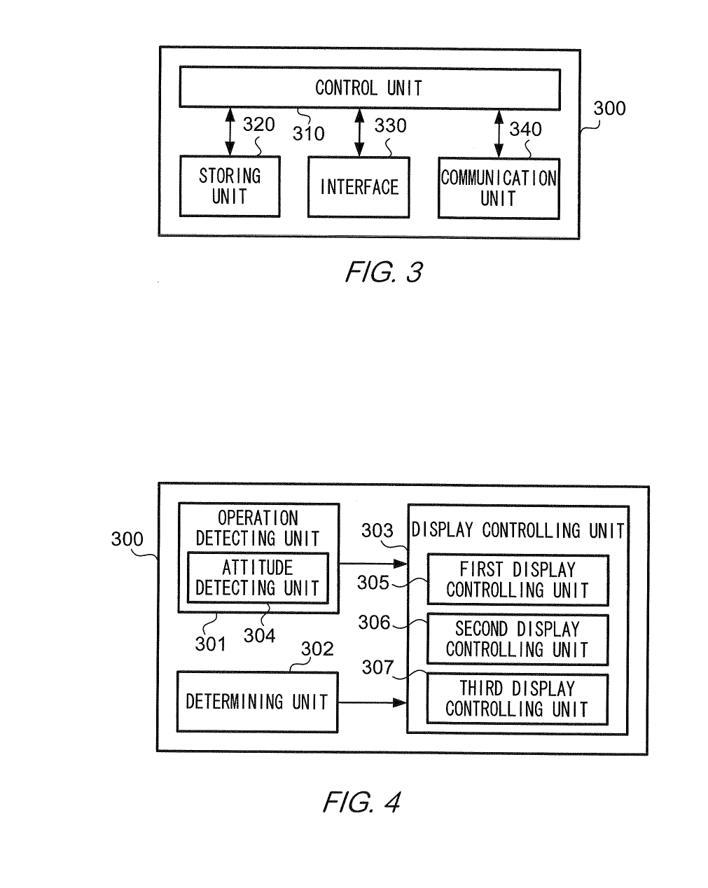

FIG. 3 shows an example of a hardware configuration of information-processing device 300. Information-processing device 300 includes control unit 310, storing unit 320, interface 330, and communication unit 340.

Control unit 310 controls hardware components of information-processing device 300. Control unit 310 includes a processor such as a CPU and/or a GPU (Graphics Processing Unit), and a memory.

Storing unit 320 stores data, and includes a storage device such as a flash memory and/or a hard disk drive. It is to be noted that storing unit 320 may include a unit for reading/writing data from/to a detachable storage medium such as a memory card and an optical disk.

Interface 330 communicates data with display device 100 and terminal device 200. In this example, interface 330 communicates with terminal device 200 by wired communication, and with terminal device 200 by wireless communication. However, methods for communicating with display device 100 and terminal device 200 are not restricted to the examples.

Communication unit 340 communicates data with server device 500 via network 400.

FIG. 4 shows an example of a functional configuration of information-processing device 300. Information-processing device 300 includes operation detecting unit 301, determining unit 302, and display controlling unit 303 and functions as a display controller in the exemplary embodiment. Further, operation detecting unit 301 includes attitude detecting unit 304. Display controlling unit 303 includes first display controlling unit 305, second display controlling unit 306, and third display controlling unit 307. Functions of these components are implemented by a program executed by control unit 310.

Operation detecting unit 301 detects an operation input by a user. Operation detecting unit 301 detects the operation input based on the operation input data transmitted from terminal device 200. Attitude detecting unit 304 detects the operation input by a user who changes an attitude of terminal device 200. Attitude detecting unit 304 detects the attitude of terminal device 200 using sensor data among operation input data. Once attitude detecting unit 304 detects an attitude of terminal device 200, detecting unit 304 may detect the attitude based on a difference between the current sensor data and previous sensor data.

Determining unit 302 determines a direction of movement on a map. In the present exemplary embodiment, a user can browse panoramic images corresponding to plural points along with a pathway (a route) on a map. Here, a direction of movement corresponds to movement from one point to another point with each point being a position from which a panoramic image is viewed. Specifically, the direction corresponds to a direction in which a road extends.

Display control unit 301 controls display device 100 and terminal device 200 to display an image corresponding to map data. Here, an image corresponding to the map data refers to an image including a map image or a panoramic image. The map data includes, for example, data described by HTML (HyperText Markup Language) and image data having a predetermined file format such as JPEG (Joint Photographic Experts Group). However, the data structure of the map data is not restricted to this example.

Display controlling unit 303 generates display data based on the map data. Data generating unit 302 executes image processing such as rendering and rasterizing, so as to generate, from the map data, display data that comply with display device 100 and terminal device 200. It is to be noted that data generating unit 302 may compress the display data to decrease data size. In such a case, terminal device 200 expands the display data before displaying an image. The image data is compressed by, for example, H.264.

First display controlling unit 305 clips, in response to an attitude detected by attitude detecting unit 304, a part of a panoramic image corresponding to a given position. Further, display controlling unit 305 controls display device 100 or terminal device 200 to display the clipped image. Hereinafter, a part of a panoramic image is referred to as a “partial image.” If the attitude detected by attitude detecting unit 304 changes, first display controlling unit 305 controls the display unit to display a new partial image in response to the change of attitude.

Second display controlling unit 306 updates a partial image displayed on display device 100 or terminal device 200, with a new partial image corresponding to a direction. Second display controlling unit 306 changes a direction of the line of sight to a direction determined by determining unit 302. Further, second display control unit 306 controls the display unit to display a partial image corresponding to the direction. In other words, second display controlling unit 306 controls the display unit to display a partial image whose center corresponds to a direction in which a road extends. Hereinafter, update of the partial image by second display controlling unit 306 is referred to as “calibration.”

Third display controlling unit 307 updates a partial image to be displayed on display device 100 or terminal device 200, from a panoramic image corresponding to a position to another panoramic image corresponding to another position. Third display controlling unit 307 clips a partial image from a panoramic image corresponding to a new position that is located along the direction determined by determining unit 302. Further, third display controlling unit 307 controls the display unit to display the partial image.

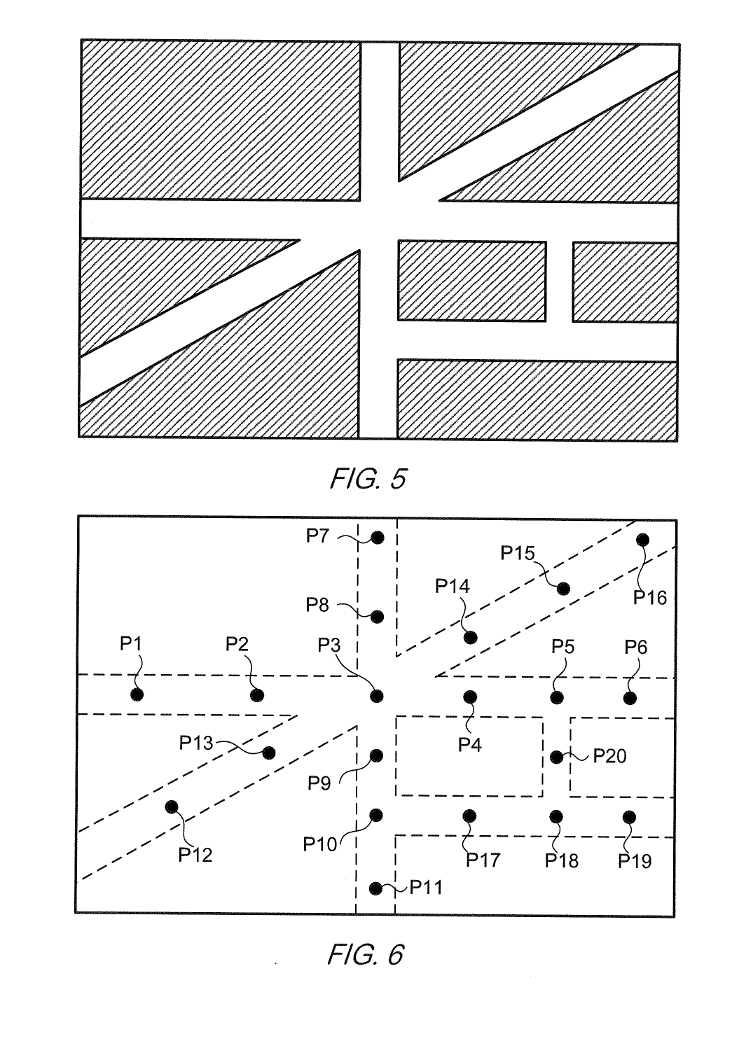

FIG. 5 shows an example of a map image. The map includes a part denoting a road and a part denoting other features. In FIG. 5, the part denoting other features is shown by hatching, for simplification. It is to be noted that the part denoting other features may be shown by a graphic representation of a building, for example. Positions on the map are identified by coordinates of a predetermined coordinate system; for example, latitude and longitude.

FIG. 6 shows an example of position data corresponding to a map image. Here, “position data” refers to a position of a panoramic image. The position data shows, for example, latitude and longitude. In the example shown in FIG. 6, position data shows that there are twenty panoramic images on roads at points P1 to P20. The distances between two each two adjacent points need not be constant. There may be more points (or panoramic images) than are shown in the example shown in FIG. 6.

A unique ID for identifying a position where a panoramic image exists may be allocated to each of the position data. Hereinafter, such an ID is referred to as a “panoramic ID.” In this example, each of reference numerals P1 to P20 is used as a panoramic ID.

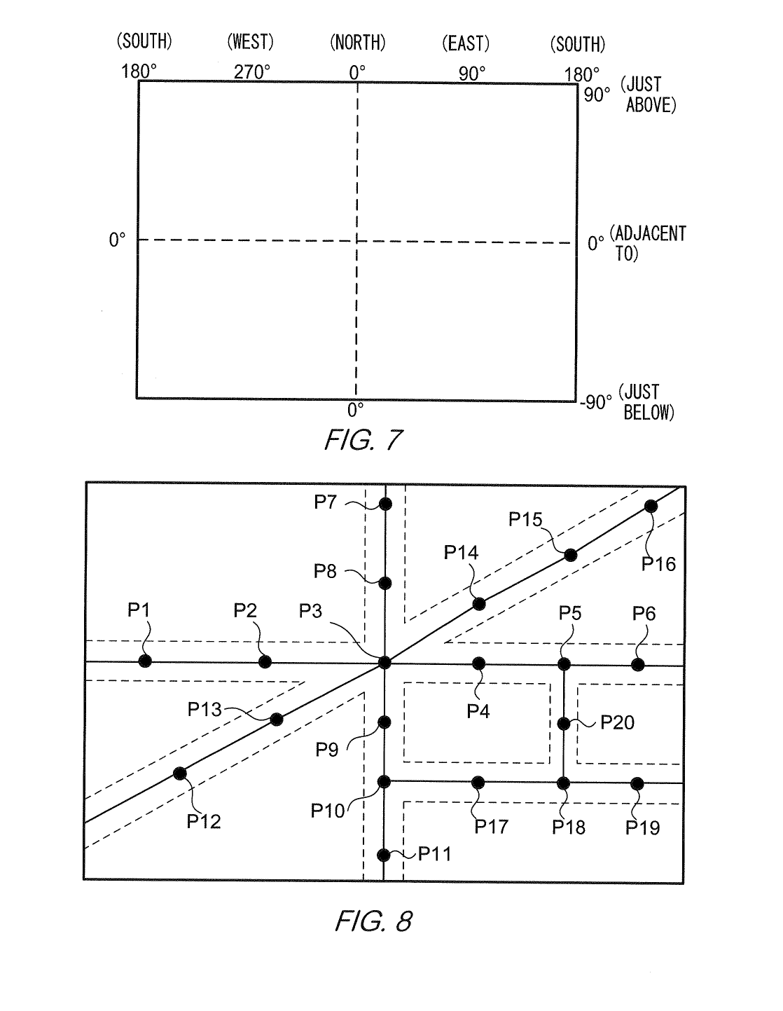

FIG. 7 shows an example of a structure of a panoramic image. In this example, the panoramic image is a rectangular image whose vertical scale corresponds to the pitch of +90° to −90° (just above to just under a horizontal direction) and whose horizontal scale corresponds to the yaw of 0° to 360° (north to north). The panoramic image is obtained by capturing images making an all-around view from a position shown by the position data. It is to be noted that, in this example, the angle corresponds to a line of sight of a user; for example, the image at the origin of the coordinate system of the panoramic image corresponding to a view seen by a user who stands at the point and faces true north.

It is to be noted that the entire panoramic image is not displayed on a single screen and only a part of the panoramic image is displayed on a single screen. A part of a panoramic image, which is clipped from the panoramic image in response to an operation input by a user, is displayed on terminal device 200. Further, the clipped part is changed in response to an operation input by a user to tilt terminal device 200. Hereinafter, a clipped part of a panoramic image is referred to as a “partial image.”

A panoramic image has a relationship with another panoramic image. Hereinafter, the relationship is referred to as a “link.” If a user instructs that the position of the viewpoint be moved, a link is formed from the current panoramic image corresponding to the current position of viewpoint to the next panoramic image corresponding to a position to which the viewpoint is moving. In other words, the link shows a candidate of a position to which a panoramic image corresponds.

FIG. 8 shows an example of links with panoramic images. The map image shown in FIG. 8 is identical to that shown in FIG. 5. In this example, a panoramic image having a panorama ID P2 (hereinafter, such a panoramic image is referred to as “panoramic image P2”) has links with panoramic images P1 and P3. As another example, panoramic image P3 has links with panoramic images P2, P4, P8, P9, P13, and P14. The number of links a panoramic image has depends on a road. If a panoramic image corresponds to a point having many candidates of a point to be linked (for example, at a crossroads), the panoramic image has many links with other panoramic images. If a panoramic image corresponds to a point on a straight road, the panoramic image has two links with a panoramic image corresponding to a forward direction and a panoramic image corresponding to a backward direction.

The configuration of displaying system 10 is as described above. A user can browse a map image and a panoramic image by using display system 10. Further, when browsing the map image, a user can browse a panoramic image by identifying a position on the map image.

In this example, a user can browse both a map image and a panoramic image with two screens of display device 100 and terminal device 200. Further, a user can change the line of sight for a panoramic image by tilting terminal device 200.

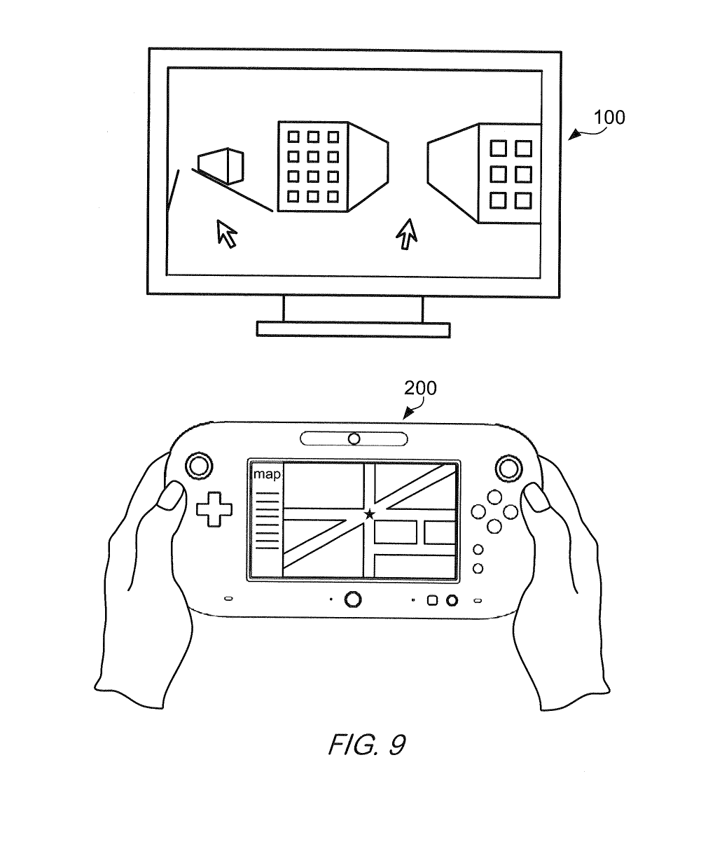

FIG. 9 shows an example of displayed images on display device 100 and terminal device 200. In the example shown in FIG. 8, a panoramic image is displayed on display device 100 and a map image is displayed in terminal device 200. If a user identifies a position on a map by touching the screen using his/her finger or a stylus, a panoramic image of the position is displayed on display device 100.

For example, if a user traces a pathway on the screen using his/her finger or a stylus, display device 100 sequentially displays panoramic images in a direction along the pathway corresponding to a direction of forward movement. According to the embodiment, a user can experience an impression of walking along the pathway.

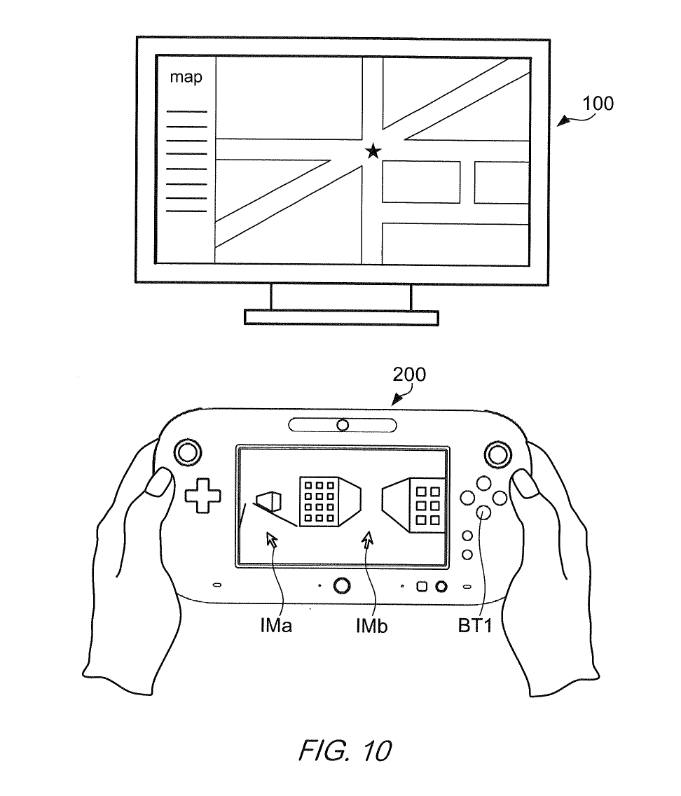

FIG. 10 shows another example of displayed images on display device 100 and terminal device 200. In the example shown in FIG. 9, a map image is displayed on display device 200 and a panoramic image is displayed on terminal device 200. A user can switch the allocation of displayed image from FIG. 8 to FIG. 9 by performing an operation input such as pushing down a button. It is to be noted that terminal device 200 displays a panoramic image from a viewpoint indicated by a star mark in the figure, which corresponds to point P3, directed to the west (left side of display device 100). In such a case, terminal device 200 may display an image showing a direction of the line of sight (for example, an arrow indicating west). Further, in FIG. 10, guide images IMa and IMb denote directions to move, and indicate that the road extends in those directions (in other words, there are other panoramic images).

In an example of FIG. 10, information-processing device 300 receives an operation input by a user in a method different from the example of FIG. 9. More specifically, in the example of FIG. 10, terminal device 200 changes the position of the viewpoint in response to a change of the attitude of terminal device 200. If a user changes the attitude of terminal device 200, the direction of the line of sight is changed in response to the attitude of terminal device 200. For example, if a user lifts up terminal device 200 so as to move the upper part of terminal device 200 towards the user and moves the lower part of terminal device 300 away from the user, terminal device 200 displays a partial image corresponding to the line of sight directed higher than the previous line of sight. A user can browse an image of any direction by moving terminal device 200. It is to be noted that, in such a case, display device 100 does not change a displayed image and continues to display the same map image. A condition for changing a map image is different from that for the partial image.

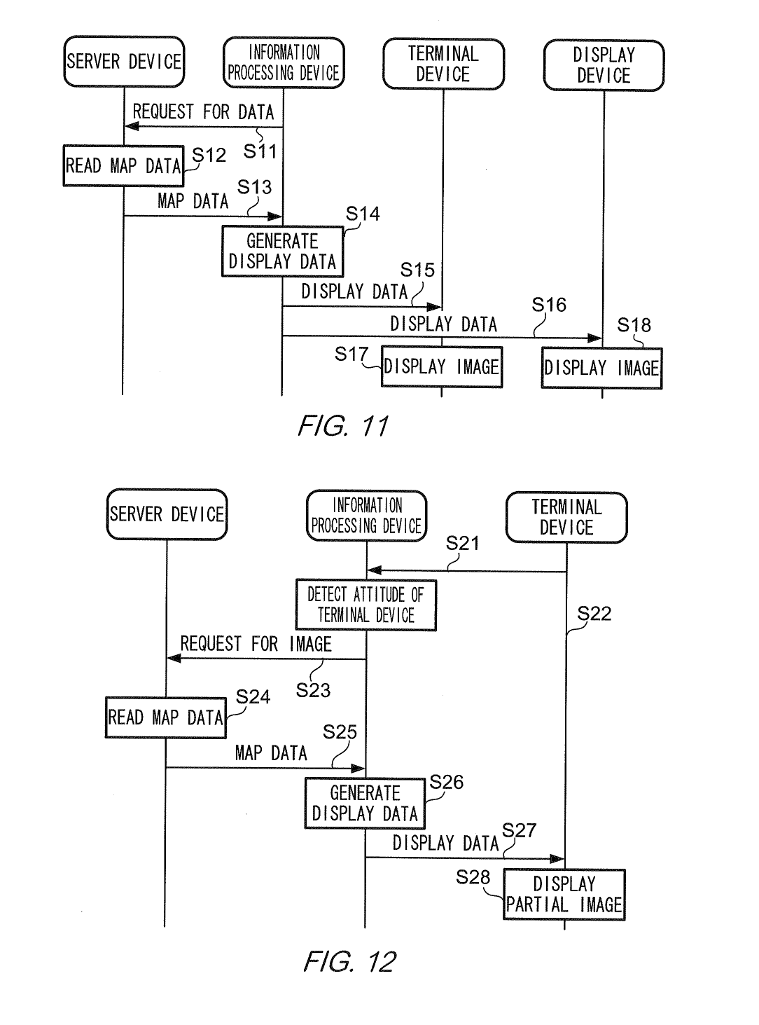

FIG. 11 shows an example of a sequence chart illustrating a process in displaying system 10. For displaying a map image and a panoramic image, information-processing device 300 transmits (in step S11) a request for data to server device 500. Information-processing device 300 transmits the request based on an operation input by a user.

The request includes information used for displaying a map image and (a part of) a panoramic image. The request includes information showing a position on the map (for example, latitude and longitude, or a panoramic ID) and a direction of the line of sight (for example, yaw and pitch, as shown in FIG. 7). It is to be noted that in a case that a user specifies a magnification of panoramic image, the request may include information showing the magnification.

When receiving the request from information-processing device 300, server device 500 reads (in step S12) map data in response to the received request. Server device 500 identifies a panoramic image to be processed in response to the request, and clips a partial image from the identified panoramic image in response to the direction of the line of sight. Then, server device 500 transmits (in step S13) to information-processing device 300 map data including at least a map image and a partial image.

There may be a case where no panoramic image exists at a position identified by a user. In such a case, server device 500 may identify the position nearest to the position identified by the user, and execute the above-described process using a panoramic image corresponding to the nearest position. Alternatively, server device 500 may notify information-processing device 300 that no panoramic image is displayed. Further, a substitute image may be displayed instead of the panoramic image.

When receiving map data, information-processing device 300 generates (in step S14) display data based on the received map data. Information-processing device 300 executes a process for predetermined image processing and generates display data for display device 100 and display data for terminal device 200. Server device 200 transmits (in steps S15 and S16) the display data to display device 100 and terminal device 200, respectively. Display device 100 and terminal device 200 display (in steps S17 and S18) images according to the received image data. Display device 100 displays one of a map image and a partial image and terminal device 200 displays the other of the map image and the partial image.

FIG. 12 shows an example of a sequence chart illustrating a process for changing a displayed image in response to an attitude of terminal device 200. Hereinafter, the process shown in FIG. 12 is referred to as a process for displaying a partial image. In this example, terminal device 200 displays a partial image. Terminal device 200 transmits (in step S21) to information-processing device 300 operation data showing the attitude of terminal device 200. When receiving the operation data, information-processing device 300 detects (or identifies) (in step S22) the attitude of terminal device 200 based on the operation data, and identifies the direction of the line of sight. Information-processing device 300 identifies a change of the line of sight by detecting a change of the attitude of terminal device 200.

Information-processing device 300 transmits (in step S23) to server device 500 a request for an image in response to the direction of the line of sight identified in step S22. It is to be noted that processes in steps S23 to S28 are identical to the processes in steps S11 to S15 and S17 shown in FIG. 11. The process shown in FIG. 12 is triggered by receipt of operation data showing a change of the attitude of terminal device 200. It is to be noted that information-processing device 300 may not change a displayed image on display device 100. Namely, information-processing device 300 may change direction (up-down or north, south, east, and west) of the image displayed on display device 100, in response to a change in yaw.

Thus, a user can browse panoramic images in various directions in the line of sight by changing the attitude of terminal device 200. Further, a user can change a viewpoint corresponding to a panoramic image. A user can, when browsing panoramic images, enjoy a virtual experience of walking along a pathway on a map. If there is an indication of a next position of the viewpoint in the screen image, a user can browse a new panoramic image corresponding to the next position of the viewpoint, by inputting an instruction via an operation input. In this example, a user can input an instruction to move to the next position of the viewpoint by pushing button BT1.

If only one subsequent position of the viewpoint is indicated in the screen image, information-processing device 300 can identify the point to which the viewpoint moves. On the contrary, if plural subsequent points are indicated in the screen image (for example, in a case at a crossroads), or if no subsequent point is indicated in the screen image, information-processing device 300 cannot identify the point to which the viewpoint moves. In the present exemplary embodiment, information-processing device 300 executes a process to display a partial image near the center of which a predetermined next position of the viewpoint is indicated, according to a predetermined rule. Hereinafter, the process is referred to as “calibration.” Calibration can prevent moving the viewpoint against the user's intention by a predetermined operation input.

In the prevent embodiment, calibration is triggered by pushing button BT1, which is identical to an operation instructing that the viewpoint be moved. Therefore, by pushing button BT1, a user can view a partial image near the center of which a predetermined road extends to the next viewpoint. Further, by pushing button BT1 again, a user can view a new partial image corresponding to the next viewpoint, which is near the center in the previous partial image. Hereinafter, the first pushing of button BT1 and the second pushing of button BT1 are referred to as “first operation” and “second operation,” respectively.

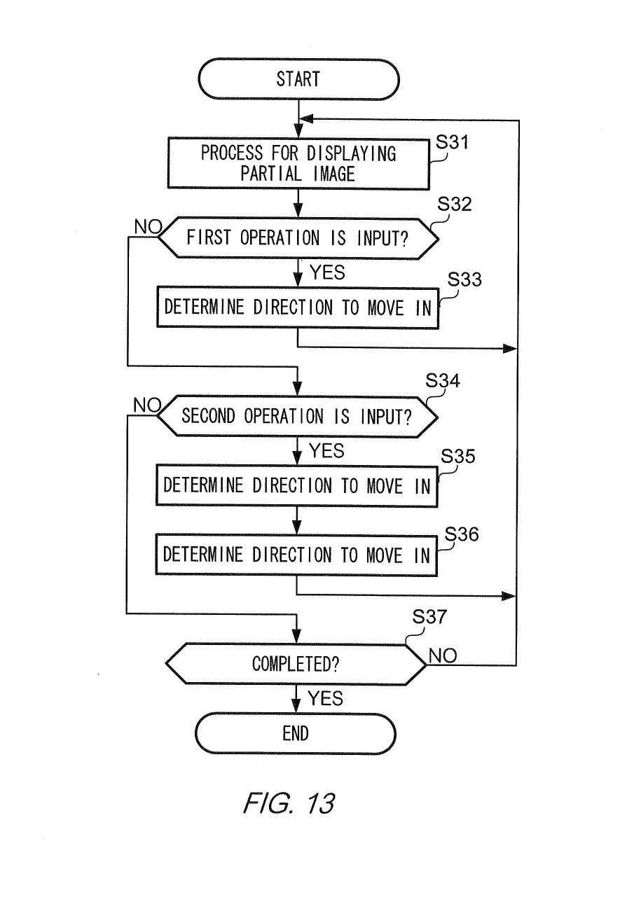

FIG. 13 shows an example of a flowchart illustrating a process for updating a displayed partial image from an image corresponding to a position to another image corresponding to another image. Here, control unit 310 of information-processing device 300 has displayed a partial image according to a process (step S31) shown in FIG. 12. The partial image displayed on terminal device 200 at this time is referred to as a “first partial image.” The first partial image is a partial image clipped in response to the attitude of terminal device 200, from a panoramic image corresponding to a position.

Control unit 310 determines (in step S32) whether the first operation is input by a user, with the first partial image being displayed on terminal device 200. In other words, control unit 310 determines whether the first operation is detected. If control unit 310 detects the first operation, control unit 310 executes the calibration and determines (in step S33) a direction in which to move. Control unit 310 can determine one direction based on the position data of the displayed panoramic image (a panoramic image including the first partial image) and the position data of panoramic images corresponding to the next viewpoint, according to a predetermined rule. The rule is as follows, for example.

Control unit 310 determines the current direction of the line of sight, using the position data of the panoramic image including the first partial image, and the position of the viewpoint. Then, control unit 310 identifies a position of other panoramic images having links with the current panoramic image. Control unit 310 identifies the directions from the current viewpoint to the other panoramic images. Control unit 310 determines, from among the panoramic images, a subsequent panoramic image a direction to which deviates least from the current line of sight. Further, control unit 310 determines the direction from the current viewpoint to the next panoramic image. Alternatively, control unit 310 may determine, from among the panoramic images, a subsequent panoramic image closest to the current panoramic image.

If there are plural panoramic images a direction to each of which deviates equally from the current line of sight, control unit 310 may determine one panoramic image according to a predetermined rule. For example, control unit 310 may determine that the next panoramic image is a panoramic image having the minimum panoramic ID. Alternatively, control unit 310 may determine that the next panoramic image is a panoramic image to which the distance is the shortest.

After determining the direction to the next position of the viewpoint, control unit 310 updates (in step S31) a partial image to be displayed on terminal device 200 from the first partial image to the second partial image, according to the process for displaying a partial image. The second partial image is clipped from the panoramic image identical to that of the first partial image. Between the first image and the second image, a corresponding direction of the line of sight is different from that of the first partial image. The direction of the line of sight corresponding to the second partial image is the direction determined in step S33, in other words, the direction in which the next panoramic image exists. It is to be noted that control unit 310 transmits a request for data to server device 500 and receives the map data, similarly to a process shown in FIG. 11. Further, control unit 310 generates the second partial image whose display data is generated based on the received map data. Control unit 310 may control the display unit to display an animation showing the update from the first partial image to the second partial image so that user can easily understand the change in the direction according to the calibration.

If the first operation is not input, control unit 310 determines (in step S34) whether the second operation is input by a user. In other words, control unit 310 determines whether the second operation is detected. If the second operation is detected, control unit 310 identifies (in step S35) the direction to which the viewpoint moves. Further, control unit 310 moves (in step S36) the viewpoint toward the determined direction. The direction determined in step S35 is, for example, the direction determined by the calibration. Subsequently, control unit 310 executes the process (step S31) for displaying a partial image so as to update the partial image displayed on terminal device 200 from the second partial image to the third partial image. The third partial image is a partial image clipped from a panoramic image corresponding to the position of the moved viewpoint. In other words, the third partial image is clipped from a panoramic image other than a panoramic image from which the first and the second partial images are clipped. Similarly to the second partial image, control unit 310 transmits a request for data and receives the map data. Further, control unit 310 generates display data based on the received map data.

If neither the first operation nor the second operation is input, control unit 310 determines (in step S37) whether the process is terminated. For example, if a specific operation is input by a user, control unit 310 determines that the process is terminated. If there is an operation input by changing the attitude of terminal device 200, control unit 310 does not terminate the process, and executes the process for displaying a partial image so as to control terminal device 200 to display a partial image in response to the attitude of terminal device 200.

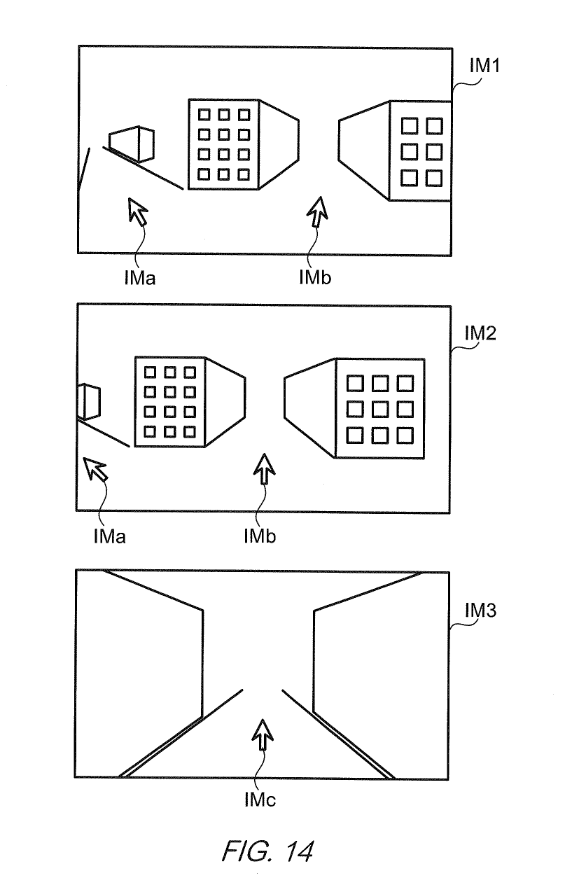

FIG. 14 shows an example of transition of screen images from the first partial image to the third partial image. In this example, first partial image IM1 is identical to the partial image displayed on terminal device 200 shown in FIG. 10. In other words, first partial image IM1 is clipped from a panoramic image corresponding to position data P3 shown in FIG. 8. Further, guide image IMa indicates the position corresponding to position data P13 shown in FIG. 8. In addition, guide image IMb indicates the position corresponding to position data P2 shown in FIG. 8.

If a user inputs the first operation when first partial image IMI is displayed, information-processing device 300 controls terminal device 200 to display second partial image IM2. In this case, information-processing device 300 identifies directions indicated by guide images IMa and IMb, and determines one direction nearer the center of the partial image, as the direction to move in. In this example, the direction indicated by guide image IMb is determined as the direction to move in. Then, information-processing device 300 controls the display unit to display second partial image IM2 in which guide image IMb is located around the center of the displayed image.

Further, if a user inputs the second operation when second partial image IM2 id displayed, information-processing device 300 controls terminal device 200 to display third partial image IM3. Third partial image IM3 is clipped from a panoramic image corresponding to a position relating to position data P3, which is the next position of the viewpoint indicated by guide image IMb. In this example, guide image IMc indicates a direction in which the next position of the viewpoint exists, in other words, a position corresponding to position data P1.

As described above, displaying system 10 provides display device 100 and terminal device 200 to display different information (a map image and a panoramic image (a partial image)) using two screens. By inputting a predetermined operation when a panoramic image is displayed on terminal device 200, a user can change the direction of the line of sight and/or the position of the viewpoint, relating to the partial image displayed on terminal device 200.

Further, according to the calibration, a user easily can understand the next position to which the viewpoint is moving by performing a predetermined operation (pushing button BT1, for example). For example, in the present exemplary embodiment, a user can determine the direction of the line of sight by briefly tilting terminal device 200, and then the user can move the next position to around the center of the partial image by the calibration. According to the calibration, a user's operation input is easier because the system does not require precise position adjustment when changing the direction of the line of sight (by changing the attitude of terminal device 200). Further, according to the calibration, a user's operation input becomes easy even if the user is in a location in which it is difficult for the user to change the attitude of terminal device 200, or even if the attitude of the user makes it difficult to change the attitude of terminal device 200.

### 2. Modification

The above exemplary embodiment is merely an example, and the present disclosure is not restricted thereto. At least two of the following modifications may be combined.

### Modification 1

The direction adjusted by the calibration is not restricted to the direction in which a road extends, in other words, the direction in which the next panoramic image exists. The calibration may adjust the center of a partial image to a predetermined direction (for example, north). According to the example, a user can easily understand the direction.

### Modification 2

The first operation and the second operation may be different from each other. For example, the first operation and the second operation may consist of a user pushing different buttons. Further, although the first operation in the above exemplary embodiment is the same (pushing button BT1) regardless of the direction in which the position of the viewpoint is moving, the first operation may change in response to the direction in which the position of the viewpoint is moving.

### Modification 3

The map image may not be displayed. In other words, the system may include only one display unit to display a panoramic image. In such a case, the display device may be one of terminal device 200 and display device 100. In other words, the terminal device may not include a display unit and merely outputs operation input data.

### Modification 4

When generating the second partial image, determining unit 302 of information-processing device 300 may determine only a horizontal position (in other words, a position along a yaw axis). The vertical position may be determined in advance. For example, in the second partial image, the vertical position may always be zero degree, in other words, just parallel to the horizontal line. According to the example, regardless of the direction of the line of sight, the direction of the line of the sight is made parallel to the horizontal line by the calibration.

### Modification 5

When generating the third partial image if there are plural panoramic images along the direction determined by determining unit 302, information-processing device 300 may clip the third partial image from one of the plural panoramic images. For example, in the exemplary embodiment, when information-processing device 300 generates third partial image IM3 shown in FIG. 14, information-processing device 300 may clip a partial image from the panoramic image corresponding to position data P1, instead of the panoramic image corresponding to position data P2.

If there are plural panoramic images along the direction determined by determining unit 302, information-processing device 300 may clip a partial image from a panoramic image that satisfies a predetermined condition. In such a case, the panoramic image satisfying the predetermined condition may be the panoramic image corresponding to the position nearest to the current viewpoint, among panoramic images having a number of links exceeding a predetermined threshold. According to the condition, information-processing device 300 is likely to skip a panoramic image corresponding to a position in a straight road, and to clip a partial image from a panoramic image corresponding to a crossroads. In the example shown in FIG. 8, only panoramic images having panoramic IDs P3, P5, P10, and P18 satisfy the condition.

The predetermined condition is not restricted to the example. For example, the predetermined condition may relate to an attribute or a rating of panoramic images. Information-processing device 300 may clip a third partial image from a panoramic image having a predetermined attribute or a rating greater than other panoramic images. Further, information-processing device 300 may control the display unit to display the third panoramic image if a predetermined operation other than the first operation and the second operation is input by a user.

### Modification 6

Instead of information-processing device 300, terminal device 200 may include attitude detecting unit 304. In such a case, terminal device 200 may transmit data showing the detected attitude (for example, pitch and yaw) to information-processing device 300 instead of the operation data.

### Modification 7

A map shown by the map data is not restricted to a map on dry land. For example, the map may be of the seabed or undersea channels. Further, the map may show geography of an astronomical body other than the earth, for example, the moon.

Further, a map shown by the map data is not restricted to a map of a real space. For example, the map may show geography of a virtual space. In such a case, images generated by 3-dimensional computer graphics may be used as the panoramic images.

### Modification 8

In display system 10, many processes are executed on information-processing device 300, and terminal device 200 includes fewer functions, like a so-called thin client. However, a display control unit of the present disclosure may be implemented on terminal device 200. In such a case, information-processing device 300 may be omitted, and terminal device 200 includes functions to receive map data and to control display device 100, for example. Further, terminal device 200 may be a so-called tablet device, a portable game device, or a smart phone. Further, information-processing device may be a console-type game device or a personal computer.

Functions of information-processing device 300 shown in FIG. 4 may be implemented by hardware and/or software. If the functions are implemented by software, plural programs may be used to implement the functions, instead of a single program. These programs may be executed in different devices. Each of these programs may be provided by a storage medium such as an optical medium or a semiconductor memory. Alternatively, these programs may be downloaded via a network.

What is claimed is:

1. A display controller comprising:
an attitude detecting unit configured to detect an attitude of a terminal device;
a first display controlling unit configured to control a display unit to display a partial image that is clipped in response to the detected attitude from a panoramic image corresponding to a position;
a determining unit configured to determine a direction in which the position is moving; and
a second display controlling unit configured to update, in response to a first operation input, an image displayed on the display unit from the first partial image to a second partial image that is clipped in response to the determined direction from the panoramic image.

2. The display controller according to claim 1, further comprising
a third display control unit configured to update, in response to a second operation input, an image displayed on the display unit from the second partial image to a third partial image that is clipped in response to the determined direction from the panoramic image.

3. The display controller according to claim 1, wherein
the first operation input is independent of the determined direction.

4. The display controller according to claim 1, wherein
the panoramic image includes a relationship between itself and another panoramic image from among a plurality of panoramic images, the relationship relating to a direction of moving from one to the other of the panoramic images, and
the determining unit is further configured to determine the direction based on the relationship.

5. The display controller according to claim 4, wherein
the relationship is determined based on a pathway on a map.

6. The display controller according to claim 5, wherein
the panoramic image corresponds to a position on the map.

7. The display controller according to claim 1, wherein
if there is a plurality of candidates of directions to which the position is moving, the determining unit is further configured to determine one direction from the candidates according to a predetermined rule.

8. The display controller according to claim 7, wherein
the determining unit is further configured to determine the one direction based on the plurality of candidates and a direction of a line of sight corresponding to the first partial image.

9. The display controller according to claim 8, wherein
if there is a plurality of candidates of directions to which the position is moving, the determining unit is further configured to determine the one direction so that a difference between the one direction and the direction of the line of sight is minimum.

10. The display controller according to claim 1, wherein
the second display controlling unit is further configured to determine the second partial image whose horizontal position is determined in response to the direction determined by the determining unit and whose vertical direction is predetermined.

11. The display controller according to claim 2, wherein
if there are a plurality of panoramic images along the direction determined by the determining unit, the third display controller is further configured to control the display unit to display the third partial image clipped from one of the plurality of panoramic images that satisfies a predetermined condition.

12. The display controller according to claim 11, wherein
the plurality of panoramic images correspond to a predetermined pathway, and
the third display controlling unit is further configured to control the display unit to display the third partial image clipped from the panoramic image corresponding to a position at a corner of the pathway.

13. A display system comprising:
a display controller; and
a display device including a display unit, wherein
the display controller includes
an attitude detecting unit configured to detect an attitude of a terminal device;
a first display controlling unit configured to control a display unit to display a partial image that is clipped in response to the detected attitude from a panoramic image corresponding to a position;
a determining unit configured to determine a direction in which the position is moving; and
a second display controlling unit configured to update, in response to a first operation input, an image displayed on the display unit from the first partial image to a second partial image that is clipped in response to the determined direction from the panoramic image.

14. A computer-readable non-transitory storage medium storing a program causing a computer device to execute a process, the process comprising:
controlling a display unit to display a partial image that is clipped in response to a detected attitude of a terminal device from a panoramic image corresponding to a position;
determining a direction in which the position is moving; and
updating, in response to a first operation input, an image displayed on the display unit from the first partial image to a second partial image that is clipped in response to the determined direction from the panoramic image.

15. A method comprising:
controlling a display unit to display a partial image that is clipped in response to a detected attitude of a terminal device from a panoramic image corresponding to a position;
determining a direction in which the position is moving; and
updating, in response to a first operation input, an image displayed on the display unit from the first partial image to a second partial image that is clipped in response to the determined direction from the panoramic image.
